(19) United States
(12) Patent Application Publication
(10) Pub. No.: US 2017/0276765 A1
(43) Pub. Date: Sep. 28, 2017

(54) LOCALIZATION APPARATUS

(71) Applicant: SICK AG, Waldkirch/Breisau (DE)

(72) Inventor: Olaf PILZNER, Hamburg (DE)

(21) Appl. No.: 15/465,696

(22) Filed: Mar. 22, 2017

(30) Foreign Application Priority Data
Mar. 23, 2016 (DE) 102016105468.2

(51) Int. Cl. G01S 5/06; H01Q 1/22; H04B 5/00

(52) U.S. Cl. CPC G01S 5/06; H04B 5/0062; H04B 5/0068; H01Q 1/2225

(57) ABSTRACT

The invention relates to a localization apparatus for radio wave-assisted localization of a transponder, the localization apparatus comprising a control device, an evaluation device, a switching device, a first linear antenna array, and a second linear antenna array. The first antenna array and the second antenna array are controllable independently of one another, are arranged cross-wise with respect to one another, and include an angle not equal to zero between them. The control device is additionally adapted to control the switching device to connect the evaluation device alternately to the first antenna array and the second antenna array. The evaluation device is adapted to determine first and second reception angles at which a radio wave signal of the transponder is incident onto one of the first antenna array and the second antenna array when the first and second antenna arrays are connected to the evaluation device, respectively.

The present invention relates to a localization apparatus for radio wave-assisted localization of a transponder, in particular of an RFID (radio frequency identification) transponder. The localization apparatus for this purpose has a plurality of antennas to be able to receive electromagnetic radio waves from the transponder as part of a detection of the transponder.

In conventional localization apparatus, the transponder is, for example, localized by a phase difference or by a time of flight difference of a received radio wave that results between two antennas of the localization apparatus. The two antennas are in this respect spaced apart by less than half the wavelength of the respective received radio wavelength such that ambiguities due to multiples of the wavelength are avoided. The transponder is in this manner, however, only localizable with respect to an angle with regard to the plane of the antennas so that this method is also known as “direction of arrival” (DOA). Only one plane can thus ultimately be determined in which the transponder is located. A more exact localization requires at least three antennas whose simultaneous control is, however, undesirably complex and whose arrangement requires a comparatively large space. It is known as an alternative for this purpose to evaluate the reception strength or the so-called RSSI (received signal strength indicator) for localizing the transponder. The RSSI, however, delivers a rough estimate of only the distance of the transponder. The RSSI has furthermore proved to be sensitive with respect to the alignment of the transponder and of interference objects in the radio wave field such that a corresponding localization of the transponder has previously only been possible with insufficient accuracy. If the transponder moves, it can be localized more exactly under certain circumstances. This is, however, in turn complex and only helpful if the transponder is actually moving.

It is an object of the invention to provide a reliable localization apparatus of the initially named kind that, on the one hand, allows a more exact localization of the transponder and, on the other hand, has a small complexity. The localization apparatus should furthermore be compact so that the assembly is simplified and the storage costs are reduced.

The object is satisfied by a localization apparatus having the features of claim 1.

The localization apparatus in accordance with the invention comprises a first linear antenna array and a second linear antenna array, wherein the first antenna array and the second antenna array can be controlled independently of one another and are arranged cross-wise with respect to one another. Furthermore, the first antenna array and the second antenna array include an angle not equal to zero between them.

In accordance with the invention, two separate antenna arrays are therefore provided for localizing the transponder, with each antenna array comprising at least two mutually spaced apart antennas that are each arranged along an imaginary straight line (linear array). The arrangement of the antenna array is crossed over in this respect, i.e. the imaginary straight lines of the two antenna arrays intersect and include an angle not equal to zero with respect to one another. The transponder is thus localizable with respect to two different spatial planes or reception angles so that at least one straight line can be determined on which the transponder is located. Since the antenna arrays are positioned cross-wise and thus overlapping, a particularly space-saving arrangement is produced overall. The localization apparatus can consequently be designed as very compact. which in many applications represents an important advantage with respect to larger localization apparatus, in particular with spatially distributed antenna arrays.

In addition, the localization apparatus in accordance with the invention comprises a control device, an evaluation device and a switching device. The control device is adapted to control the switching device to connect the evaluation unit alternately to the first antenna array and to the second antenna array, with the evaluation device being adapted to determine a first reception angle at which a radio signal of the transponder is incident onto the first antenna array when the first antenna array is connected to the evaluation device, and with the evaluation device furthermore being adapted to determine a second reception angle at which a radio wave signal of the transponder is incident onto the second antenna array when the second antenna array is connected to the evaluation device. In this manner, only one evaluation device is required to determine the two reception angles, which reduces the manufacturing costs and the error proneness of the localization apparatus to a considerable degree. The implementation of the switching device is in this respect associated with comparatively small costs that do not have a negative effect in total. The fact that the two reception angles cannot be detected directly simultaneously is not a problem in most applications since the reception angles can, for example, be measured directly behind one another as part of two detection procedures and only a small time difference results. A sequential measurement of the reception angles is in particular sufficient to be able to ensure a high localization accuracy with transponders which are only moved at low speed or which should only be detected in the unmoved state, i.e. the static state. It is understood that separate electronics, in particular a separate evaluation device, can be provided for each antenna array if a simultaneous angle determination is desired e.g. for localizing fast-moving transponders.

The first antenna array and the second antenna array preferably extend in a common plane. The localization accuracy can hereby be increased, with the computation effort for the localization simultaneously being reduced, in particular with respect to a calibration of the localization apparatus. The localization apparatus can furthermore be of a flat and thus compact design.

The first antenna array and the second antenna array can be of like designs, i.e. the individual antennas, the positions and/or the interconnection of the antennas of the respective antenna arrays can be similar or even identical. The number of like parts of the localization apparatus or the number of like manufacturing procedures can thus be increased to save costs and to reduce the risk of assembly errors. Furthermore, similar or identical antenna arrays are advantageous under the aspect of a high localization accuracy since deviations from the specification of the individual antenna arrays caused by the manufacture or by the operation essentially mutually compensate one another.

In accordance with an advantageous embodiment, the first antenna array and the second antenna array are formed by a respective antenna pair, i.e. both antenna arrays each only comprise two antennas. It is, however, alternatively also possible to provide more than two antennas per antenna array, for example to increase the localization accuracy even more depending on requirements.

In accordance with a further embodiment, the first antenna array and the second antenna array have a common point of intersection that corresponds to a geometrical center of the first antenna array and of the second antenna array. The point of intersection is in this respect defined by that point at which the imaginary straight lines intersect that each characterize the linear direction of extent of the two antenna arrays. The point of intersection can thus be equally far away from the two ends of the first antenna array and from the two ends of the second antenna array. The localization apparatus can also be designed as compact for this reason, with a symmetrical design and a parallelepiped shape additionally being able to be realized.

The angle that the first and second antenna arrays include between them preferably amounts to at least substantially ninety degrees. The antenna arrays are therefore arranged orthogonally with respect to one another. The localization calculation is hereby simpler and can additionally take place at higher accuracy since the respective measurement planes differ from one another by a maximum with respect to their angle. On a use of two antenna pairs in one plane, a 2×2 antenna matrix results in which the antennas are arranged in the four corners of an imaginary square and are spaced apart equidistantly from one another along the periphery.

The first antenna array and the second antenna array can be fastened to a common carrier for implementing a localization apparatus having a simple and compact design. For example, a common substrate, in particular a circuit board or a lead frame, can be provided for the two antenna arrays.

In accordance with a further embodiment, the localization apparatus comprises an antenna module having a module housing, wherein the first antenna array and the second antenna array are together accommodated in the module housing. The localization apparatus is thus particularly easy to handle and is in particular protected from outside influences in the course of the assembly or during operation. The localization apparatus is thus, for example, suitable for use in an industrial environment in which apparatus—without any corresponding protection—dust, moisture and the like could impair the correction operation of the localization.

The control device, the evaluation device and the switching device can advantageously be accommodated in the named module housing such that the electronics of the localization apparatus are protected by the housing in addition to the antenna arrays.

The evaluation device is preferably adapted to offset the first reception angle and the second reception angle with respect to one another to determine a direction vector of the transponder. In other words, a straight line can be determined that, starting from the localization apparatus, indicates the direction of the transponder, i.e. the transponder “is seated” on the straight line. It is understood that the calculation of the direction vector can alternatively be carried out in the control device if no separate evaluation device is provided or if it is integrated into the control device.

In accordance with a further embodiment, the evaluation device is adapted to offset the first reception angle and the second reception angle as well as a piece of information on a predefined plane in which the transponder is located against one another to determine a position of the transponder. In other words, a point of intersection of the above-named direction vector can be determined using the predefined plane to determine the position of the transponder with respect to all three spatial coordinates. The information on the predefined plane can, for example, comprise a predefined distance between the localization apparatus and the floor of a factory building in which the localization apparatus and the transponder are located. In this respect, the information is used that the transponder is e.g. always in direct vicinity to the floor, e.g. when the transponder is attached to a trolley of an automatic conveyor system. The localization apparatus can in this respect e.g. be fastened to a central point at the ceiling of the factory building. The information on the ceiling height can be stored, for example, in a memory of the localization apparatus to be able to localize the transponder as part of a detection procedure in the plane of the building floor.

The invention will be explained only by way of example in the following with reference to the drawings in which:

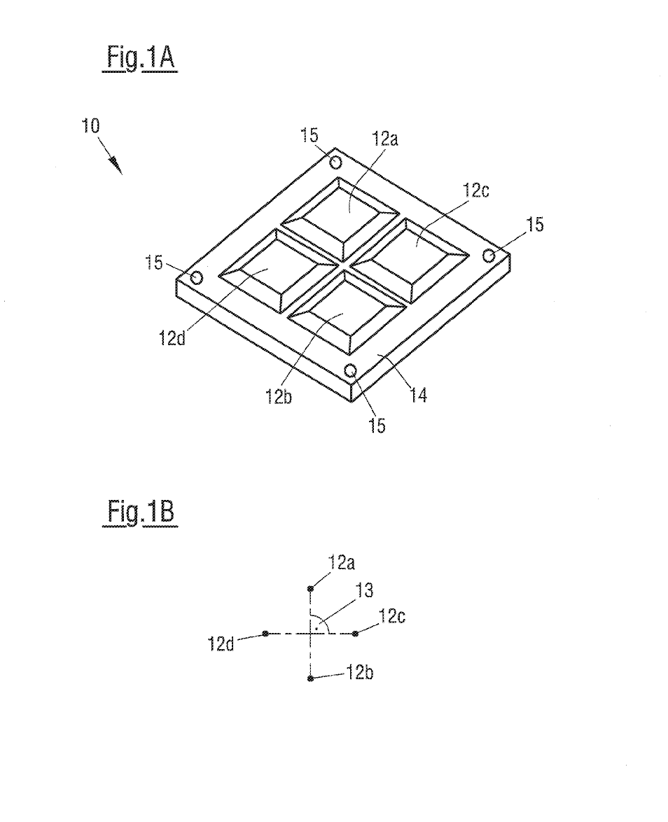

FIG. 1A shows a localization apparatus in accordance with the invention;

FIG. 1B shows a schematic overview of the arrangement of antennas of the localization apparatus of FIG. 1A; and

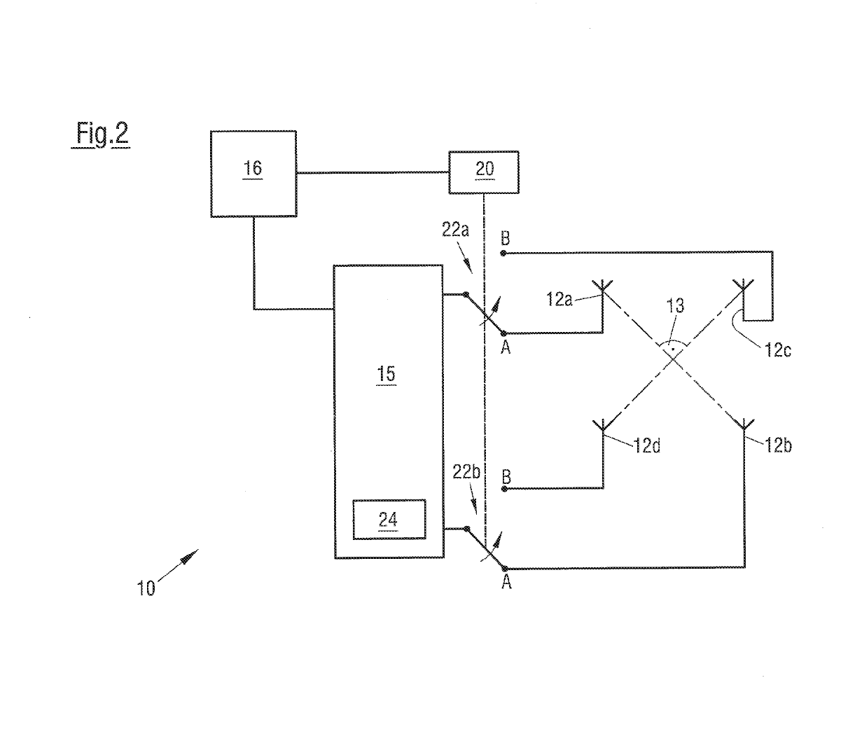

FIG. 2 shows a schematic circuit diagram of a localization apparatus.

A localization apparatus 10 shown in FIG. 1A comprises four like antennas 12 that are arranged on a common square base plate 14. The antennas 12a and 12b form a first linear antenna array and the antennas 12c and 12d form a second linear antenna array, wherein the first antenna array and the second antenna array cross with respect to their linear extent and include an angle 13 of ninety degrees with one another (FIG. 1B). The antennas 12 are thus arranged in a 2×2 matrix configuration, with the respective diagonally oppositely disposed antennas 12 forming a respective antenna pair. The antenna arrays can be controlled independently of one another.

The base plate 14 has a respective passage 15 at the corners to be able to fasten the localization apparatus 12 using known fastening means such as screws to a desired location, in particular to a room ceiling or building ceiling (not shown) (FIG. 1A). The base plate 14 can furthermore have a hollow space, not shown, for receiving electronics to be able to operate the localization apparatus 10 substantially autonomously. The antennas 12 can be encapsulated and can thus be protected from dirt, moisture and the like. The localization apparatus 10 is designed as a compact antenna module in the embodiment shown such that the localization apparatus 10 can be installed in a space-saving and simple manner.

The localization apparatus 10 is configured to localize an RFID transponder, not shown. The electronics of the localization apparatus 10 can be designed as shown in FIG. 2 for this purpose. The electronics comprise a control device 16, an evaluation device 18 and a switching device 20. The switching device 20 is coupled to two switches 22a and 22b that are simultaneously switched between a position A and a position B. In the position A shown in FIG. 2, the antennas 12a and 12b are connected to the evaluation device 18 and the antennas 12c and 12d are separate from the evaluation device 18. It is the opposite in the position B, i.e. the antennas 12c and 12d are connected to the evaluation device 18 and the antennas 12a and 12b are separate from the evaluation device 18. The evaluation device 18 is adapted to determine a reception angle at which a radio wave of a transponder (not shown) is incident onto the first or second antenna array.

An exemplary localization procedure of the transponder takes place as follows: The switches 22a, 22b are first in the position A (FIG. 2). A radio wave is transmitted via one or more antennas 12 to detect the transponder. At the same time, the evaluation device 18 is adapted to determine a first reception angle at which a radio wave transmitted by the transponder is incident onto the first antenna array having the antennas 12a and 12b. The control device 16 then controls the switching device 20 to switch the switches 22a, 22b into the position B. The evaluation device 18 can now determine a second reception angle at which a radio wave transmitted by the transponder is incident onto the second antenna array having the antennas 12c and 12c. Depending on the transmission duration of the transponder, the determination of the two reception angles can take place as part of only one detection procedure (localization apparatus 10 only transmits one radio wave) or of two detection procedures (localization apparatus 10 only transmits a further radio wave as part of the switchover). The determined first and second reception angles can be used by the evaluation device 18 for determining a direction vector of the transponder or can be transmitted directly to a higher-ranking calculation device. If a localization is already being autonomously carried out in the evaluation device 18, a complete localization of the transponder can take place while taking account of a piece of information stored in a memory 24 of the evaluation device 18. The information can in particular comprise a value that indicates the distance between the localization apparatus 10 and a plane in which the transponder is always located.

### REFERENCE NUMERAL LIST

10 localization apparatus
12 antenna
14 base plate
15 passage
16 control device
18 evaluation device
20 switching device
22 switch
24 memory

1. A localization apparatus for radio wave-assisted localization of a transponder, the localization apparatus comprising a control device, an evaluation device, a switching device, a first linear antenna array, and a second linear antenna array,
wherein
(i) the first linear antenna array and the second linear antenna array
are configured to be controlled independently of one another;
are arranged cross-wise with respect to one another; and
include an angle not equal to zero between them:
(ii) the control device is adapted to control the switching device to connect the evaluation device alternately to the first linear antenna array and to the second linear antenna array;
(iii) the evaluation unit is adapted to determine a first reception angle at which a radio wave signal of the transponder is incident onto the first linear antenna array when the first linear antenna array is connected to the evaluation device; and
(iv) the evaluation unit is further adapted to determine a second reception angle at which a radio wave signal of the transponder is incident onto the second linear antenna array when the second linear antenna array is connected to the evaluation device.

2. The localization apparatus in accordance with claim 1,
wherein the first linear antenna array and the second linear antenna array extend in a common plane.

3. The localization apparatus in accordance with claim 1,
wherein the first linear antenna array and the second linear antenna array are of like design.

4. The localization apparatus in accordance with claim 1,
wherein the first linear antenna array and the second linear antenna array are formed by a respective antenna pair.

5. The localization apparatus in accordance with claim 1,
wherein the first linear antenna array and the second linear antenna array have a common point of intersection that corresponds to a geometrical center of the first linear antenna array and of the second linear antenna array.

6. The localization apparatus in accordance with claim 1,
wherein the angle amounts to at least substantially ninety degrees.

7. The localization apparatus in accordance with claim 1,
wherein the first linear antenna array and the second linear antenna array are fastened to a common carrier.

8. The localization apparatus in accordance with claim 1,
wherein the localization apparatus comprises an antenna module having a module housing, wherein the first linear antenna array and the second linear antenna array are together accommodated in the module housing.

9. The localization apparatus in accordance with claim 8,
wherein the control device, the evaluation device and the switching device are accommodated in the module housing.

10. The localization apparatus in accordance with claim 1,
wherein the evaluation device is adapted to offset the first reception angle and the second reception angle with respect to one another to determine a direction vector of the transponder.

11. The localization apparatus in accordance with claim 1,
wherein the evaluation device is adapted to offset the first reception angle and the second reception angle as well as a piece of information on a predefined plane in which the transponder is located against one another to determine a position of the transponder.

12. The localization apparatus in accordance with claim 1,
wherein the transponder is an RFID (radio frequency identification) transponder.
